(19) United States
(12) Patent Application Publication
(10) Pub. No.: US 2025/0074552 A1
(43) Pub. Date: Mar. 6, 2025

(54) Aquatic Support Vessel

(71) Applicant: AEPLOG, Inc., Rockville, MD (US)

(72) Inventors: William M. Teppig, Jr., Mechanicsburg, PA (US); James S. Whang, Rockville, MD (US)

(21) Appl. No.: 18/817,493

(22) Filed: Aug. 28, 2024

Related U.S. Application Data
(60) Provisional application No. 63/579,669, filed on Aug. 30, 2023.

(51) Int. Cl. B63B 25/00; B60L 53/80; B63B 27/12; B63B 43/00; B66C 17/04

(52) U.S. Cl. CPC B63B 25/004; B60L 53/80; B63B 27/12; B63B 43/00; B66C 17/04

(57) ABSTRACT

An aquatic support vessel including a storage rack configured to stow one or more modular marine vessels. The aquatic support vessel further includes a gantry crane having a rigid, extendable column configured for lifting one or more of the modular marine vessels out of the storage rack and placing one or more of the modular marine vessels into the storage rack.

### CROSS-REFERENCE TO RELATED APPLICATIONS

The present application claims the benefit of U.S. provisional patent application 63/579,669, entitled “GHOST CONTAINER SHIPS TO RAPIDLY DEPLOY, RETRIEVE AND SERVICE SEA TRUCKS,” filed on 30 Aug. 2023, the entire disclosure of which is incorporated herein by reference.

### TECHNICAL FIELD

The present disclosure generally relates to aquatic vessels, and more particularly relates to aquatic support vessels for supporting operations of modular maritime vessels.

### BACKGROUND

Relatively small and configurable marine vessels can be utilized in many applications and may provide a multitude of benefits and advantages. For example, small, configurable marine vessels may be utilized as easily configurable research platforms, supply carriers, aid vehicles, as well as various offensive and/or defensive military applications. While such small, configurable marine vessel may have a wide range of applications, and provide many advantages, the need to configure, supply, and maintain such vessels from a shore-based facility may provide certain limitations. For example, the need for shore-based operations may limit the effective range of the small, configurable marine vessels. Additionally, depending upon the locations of such necessary shore-based support, the response time available from such small, configurable marine vessels may be greatly increased.

### SUMMARY

According to an implementation an aquatic support vessel includes a storage rack configured to stow one or more modular marine vessels. The aquatic support vessel further includes a gantry crane system having a rigid, extendable column(s) configured for lifting one or more of the modular marine vessels one or more of out of the storage rack and placing into the storage rack.

One or more of the following features may be included. At least a portion of the one or more modular marine vessels include a sea truck. The sea truck may include a bow module, a payload module including one or more of an ISO standard intermodal container and a support frame having ISO standard intermodal container dimensions. The sea truck may further include a propulsion module. One or more of the bow module, the payload module, and the propulsion module include a plurality of ISO standard intermodal container three-face twistlock connector features for coupling with at least another of the bow module, the payload module, and the propulsion module.

The storage rack may be configured to stow a plurality of the one or more modular marine vessels in a vertically stacked configuration. The aquatic support vessel may further include a fire control system associated with the storage rack. The aquatic support vessel may further include an inventory control system. The inventory control system may be configured to identify one or more of a number of modular marine vessels contained within the storage rack, a location of one or more modular marine vessels within the storage rack, a configuration of one or more modular marine vessels within the storage rack, and a status of one or more modular marine vessels within the storage rack.

The aquatic support vessel may further include a charging system configured to charge one or more batteries associated with one or more modular marine vessels within the storage rack. The aquatic support vessel may further include a communication system configured to communicate with one or more modular marine vessels. The communication system may communicate with one or more modular marine vessels to one or more of: identify the one or more modular marine vessels, determine a configuration of the one or more modular marine vessels, determine a status of the one or more modular marine vessels, and provide instructions to the one or more modular marine vessels.

The aquatic support vessel may further include one or more of: a replacement rack configured to stow one or more spare module components for the modular marine vessels, and a removed component rack configured to stow one or more module components removed from the modular marine vessels. The replacement rack includes an alignment feature for aligning a stowed spare module component with a payload component of one or more of the modular marine vessels for assembling the stowed spare module component with the payload component. The gantry crane may be configured to position a payload module for one or more of the modular marine vessels adjacent the replacement rack for attachment of a spare module component to the payload module. The gantry crane may be configured to position one or more of the modular marine vessels adjacent the removed component rack for removal of a module component from one or more modular marine vessels and stowing of the module component in the removal rack.

The gantry crane may include a trolley having at least a first extendable column and a second extendable column. Each of the first extendable column and the second extendable column may be configured for lifting a respective one of the one or more of the modular marine vessels out of the storage rack or placing a respective one of the one or more of the modular marine vessels into the storage rack. The storage rack may include at least a first storage rack and a second storage rack. The first extendable column may be configured for lifting one of the one or more modular marine vessels from the first storage rack and placing one of the one or more modular marine vessels into the first storage rack. The second extendable column may be configured for lifting one of the one or more modular marine vessels from the second storage rack and placing one of the one or more modular marine vessels into the second storage rack. The first and second extendable columns may be configured to lift a respective one of the one or more modular marine vessels from the first storage rack and the second storage rack and to place a respective one of the one or more modular marine vessels into the first storage rack and the second storage rack without repositioning the trolly of the gantry crane.

The aquatic support vessel may further include a retrieval system. The retrieval system may include a retrieval platform deployable over a side of the aquatic support vessel to a position at least partially below a surrounding water surface to enable one or more of the modular marine vessels to navigate one or more of onto and above the retrieval platform. The retrieval system may include a constant lift force mechanism for raising the retrieval platform and a modular marine vessel from the surrounding water surface. The retrieval platform may be moveable between a first portion oriented generally parallel with a side of the aquatic support vessel, and a second position generally parallel with the surrounding water surface. The retrieval system may include one or more bollards associated with the retrieval platform. The one or more bollards may facilitate navigation of the one or more modular marine vessels to navigate to a desired position with respect to the retrieval platform.

The aquatic support vessel may further include one or more cushioned bollards that are deployable over a side of the aquatic support vessel to a position at or below a surrounding water surface. The one or more cushioned bollards may be configured to enable a modular maritime vessel to navigate against the one or more cushioned bollards to achieve an orientation generally parallel against the side of the aquatic support vessel. The gantry crane may be configured to retrieve the modular maritime vessel from the generally parallel orientation against the side of the aquatic support vessel.

### BRIEF DESCRIPTION OF THE DRAWINGS

FIG. 1 diagrammatically depicts an aquatic support vessel, according to one embodiment;

FIG. 2 diagrammatically depicts a storage rack system for stowing modular marine vessels on an aquatic support vessel, according to one embodiment;

FIG. 3 diagrammatically depicts a top-end view of a storage rack system for stowing modular marine vessels on an aquatic support vessel, according to one embodiment;

FIGS. 4-6 diagrammatically depict a process for launching modular marine vessels from an aquatic support vessel, according to one embodiment;

FIG. 7 diagrammatically depicts a replacement module storage rack system, according to one embodiment;

FIGS. 8-11 diagrammatically depict a process for replacing one or more modules of a modular marine vessel, according to one embodiment;

FIG. 12 diagrammatically depicts a modular marine vessel retrieval system utilized by an aquatic support vessel, according to one embodiment;

FIGS. 13-16 diagrammatically depict a process for retrieving a modular marine vessel from the water utilizing the retrieval system of FIG. 12, according to one embodiment; and

FIGS. 17-19 diagrammatically depict a cushioned bollard retrieval system and process for recovering modular marine vessels from the water, according to one embodiment.

### DETAILED DESCRIPTION OF EXAMPLE EMBODIMENTS

Consistent with some aspects the present disclosure may generally relate to aquatic support vessels, which manage and/or provide support for maritime operations. In some particular implementations, aquatic support vessels consistent with the present disclosure may facilitate, support, and/or manage maritime operations for modular maritime vessels, including, but not limited to, maritime operations of sea trucks. Consistent with various implementations, an aquatic support vessel may transport one or more modular maritime vessels to a possible, or intended, area of operation for the modular maritime vessels. In some example embodiments, an aquatic support vessel may include storage for one or more modular maritime vessels, e.g., which may be transported by the aquatic support vessel. Further, in some implementations, an aquatic support vessel may maintain, service, assemble, configure, and/or repair one or more modular maritime vessels. Consistent with some such implementations, an aquatic support vessel may store one or more component modules of a modular maritime vessel. According to some implementations, the operational range of the modular maritime vessels may be increased. In some example implementations, an aquatic support vessel may have capabilities to launch or deploy modular maritime vessels to a body of water. Further, in some implementations an aquatic support vessel may have capabilities to retrieve or recover modular maritime vessels from a body of water. Various additional and/or alternative implementations and capabilities may be realized consistent with the present disclosure.

Consistent with some aspects, the present disclosure may generally encompass systems and/or processes related to launching and recovering modular maritime vessels from an aquatic support vessel. In various implementations, the aquatic support vessel may be totally unmanned (e.g., fully automated and/or remotely controlled). In other implementations, the aquatic support vessel may be manned to varying degrees. For example, an aquatic support vessel may be fully manned with personnel to carry out all operations related to navigating the aquatic support vessel, as well as overseeing operations of the modular maritime vessels. In a further example embodiment, the aquatic support vessel may be lightly manned, e.g., with minimal personnel to oversee navigation and/or operation of the aquatic support vessel, with all operations relating to the modular maritime vessels being automated and/or remotely controlled. Various additional and/or alternative degrees of automated operations, remotely controlled operation and/or manned operation may be implemented.

In some example implementations, an aquatic support vessel may be equipped with a series of subsystems to assemble, disassemble, store, stow, maintain, repair, service, release to a body of water and retrieve from a body of water one, or multiple, modular maritime vessels at numerous sea states without relying on dockside amenities such as shore-to-ship cranes, ship-to-shore cranes, ship-to-ship cranes or shore-to-shore cranes. In some example implementations, an aquatic support vessel may be implemented to realize distributed, discreet, quick, and efficient modular maritime vessel launches, retrievals (in-situ), and services, which can revolutionize fields like emergency responses, transportation of goods, military operations, and sustainment and services of offshore facilities/platforms.

Accordingly, to some implementations, the present disclosure may address the problem of rapid, efficient, and/or stealthy offloading and recovery of modular maritime vessels directly by an aquatic support vessel, including at elevated sea states and/or under inclement weather conditions. Consistent with some embodiments, the operating range of modular maritime vessels may be expanded for tasks including, but not limited to, (a) the distributed delivery of commercial products across a shoreline for commercial operations, emergency responses, and/or military operations, (b) the covert deployment of military devices/units for strategic/tactical operations, and/or (c) servicing, supporting, and sustaining offshore platforms/rigs from a vessel that may, in some implementations, be totally unmanned. Some embodiments consistent with the present disclosure may provide various systems, sub-systems, and/or devices that may work in unison and/or coordination aboard a single aquatic support vessel (e.g., which may variously be configured to oceanic environments, seas, lakes, rivers, inland-waterways, and/or any other aquatic environments) to fulfill one or more of the tasks of assembly, storage, stowage, deployment, and recovery/retrieval of modular maritime vessels to and from a given body of water. The following description of particular systems, sub-systems, devices and the like that may be implemented to realize one or more aspects or features are intended for the purpose of example and illustration, as other variations may also be implemented.

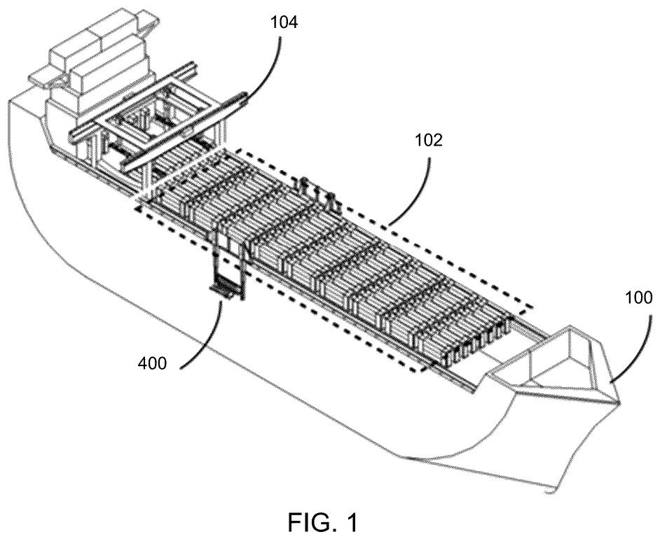

Referring to FIG. 1, an illustrative example embodiment of an aquatic support vessel 100 is generally shown. Consistent with various implementations, the aquatic support vessel may be configured for operation in a variety of aquatic environments, including, but not limited to, oceans, seas, lakes, rivers, inland waterway, as well as any other aquatic environments. The size and configuration of the aquatic support vessel may, accordingly, vary to suit the intended operational environment. In the depicted example embodiment, the aquatic support vessel 100 is generally configured as a cargo vessel. The aquatic support vessel 100 may generally include a storage rack 102, generally, configured to stow one or more modular marine vessels. Additionally, the aquatic support vessel may include a gantry crane 104 having a rigid, extendable column configured for lifting one or more of the modular marine vessels out of the storage rack 102 and/or placing one or more of the modular marine vessels into the storage rack 102. Accordingly, the aquatic support vessel may be configured to support maritime activities of the one or more modular marine vessels, including, but not limited to, one or more of storing the modular marine vessels, configuring the modular marine vessels for various operations, maintaining the modular marine vessels, repairing the modular marine vessels, deploying the modular marine vessels into the water, and/or recovering the modular marine vessels from the water.

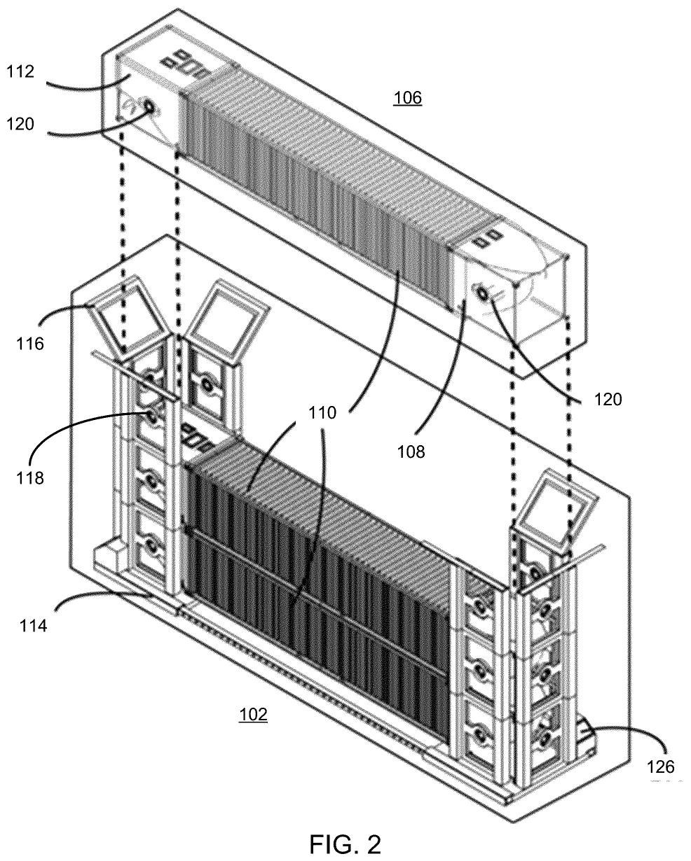

With additional reference to FIG. 2, consistent with some example embodiments, at least a portion of the one or more modular marine vessels may include a sea truck 106. However, the modular marine vessels may include various alternative modular maritime vessels. Consistent with some implementations, a sea truck 106 may include a modular maritime vessel, which may be rapidly assembled, configured, and/or repaired by virtue of the modular nature of the sea truck. A sea truck may be configured for a variety of civilian and/or military applications. For example, a sea truck may provide an economical platform for comparatively small volume cargo transport, easily configurable research platform, or the like. Additionally, a sea truck may be configured for various offensive and/or defensive military applications.

For example, consistent with some embodiments of the present disclosure, sea trucks may allow offensive or defensive missile systems to be transported, stowed, and launched from an extremely small vessel-ISO container sized. Further, in some embodiments, sea trucks may be utilized to deploy radars/radar jammers or other sensor arrays. Such applicants may greatly expand military capabilities in a dispersed, controlled, and very cost-effective manner. Additionally, through the use of remote command and control (e.g., which may include satellites and aircraft) deployed sea trucks can be monitored, controlled, and surveilled (for detecting adversary intervention forces/elements). In some implementations, this may allow an entire deployed “fleet” of stabilized sea trucks to respond to changing operations as a coordinated “swarm” in a highly effective manner. Examples of some of the capabilities that sea trucks may utilize may include, but are not limited to onboard missile(s), missile launcher(s), radar(s), laser gun(s), other direct/indirect high-energy gun(s)/weapon(s), torpedo launcher(s), manned/unmanned vehicles/vessels/platforms (air, surface, amphibious, ground and/or submerged), other existing or new defensive/offensive weapon(s), radar/laser jammers/deception devices, cyber/anti-cyber warfare system(s), radar/other decoys, satellite/tele-communication system(s), reconnaissance/surveillance/intelligence system(s), and/or other apparatus that may or may not require elevation from the water surface for increased functioning.

Further, as generally suggested, sea trucks may be used individually and/or as a collective of sea trucks that may be launched from a ship, a water-based platform, and/or a shore-based platform. Control of the sea trucks (to include activation, launching, retrieval, partial/complete destruction, or sinking) may be pre-programmed, fully autonomous utilizing GPS, internal Inertia Navigation or “dead reckoning” and/or controlled by ship, aircraft, land station, or satellite.

Generally, the sea truck 106 may include a bow module 108, a payload module 110, and a propulsion module 112. Consistent with some implementations, the sea truck 106 may be configured around the ISO standard intermodal container form factor, and the payload module 110 may include an ISO standard intermodal container or a support frame having ISO standard intermodal container dimensions. As is generally known, the specifications for an ISO standard intermodal container may be set by the International Organization for Standardization (also known as the “ISO”). These ISO specifications may include standards for dimensions, forms, strength, water-tightness, mobility, and security. The size of such ISO standard intermodal containers is typically forty feet long, eight feet wide and eight feet six inches high (i.e., 40′×8′×8′−6′) and can weigh over thirty-four tons fully loaded with a capacity of over 2,720 cubic feet. Other ISO standard containers can measure 20′×8′×8′-6″, 45′×8′×8′-6″, or 45′×8′×9′−6″. According to various implementations contemplated consistent with the present disclosure, the design, the overall lengths, widths and heights of the sea truck may vary to meet the operational task/components.

One or more of the bow module, the payload module, and the propulsion module include a plurality of ISO standard intermodal container three-face twistlock connector features for coupling with at least another of the bow module, the payload module, and the propulsion module. As is generally known, ISO standard twistlock connectors may be located at, at least, each corner of the ISO standard container form factor. As set forth by the ISO standard, the three-face twistlock connectors may allow connection to adjacent containers, components, and/or features at each of the three planes of the corner (e.g., an X-Y plane, an X-Z plane, and a Y-Z plane, representing each of the three faces of a container corner). In some implementations, the ISO standard twistlock connectors may be used to couple one or more of the bow module 108 and the propulsion module 112 to the payload module 110. It should be noted that, herein, the reference to ISO standard twistlock connectors may include the three-faced casting for receiving a twistlock connector and/or may include the twistlock connector feature (e.g., which may be coupled to the three-faced casting). In addition to the standard ISO connectors located at each corner of the payload module, additional ISO connectors may be located at other points on the stabilizer housing and/or cargo feature to facilitate connection with other components and/or modules. Additional commercial “clamp-style connectors may be used to facilitate connections.

As shown in the illustrated example embodiment of FIG. 2, the sea truck 106 is implemented in its most basic configuration, may include the bow module 108, the payload module 110, and the propulsion module 112, all of which may conform to size, shape, and form factors of ISO standard intermodal containers (including standardized corner connection points). As noted above, the sea truck 106 (as well as any other modular marine vessels that may be utilized in connection with the aquatic support vessel) can be manned or unmanned, whether remotely controlled, semi-autonomous, or fully autonomous, and can operate in isolation or as part of a larger fleet/swarm. The depicted sea truck 106 is defined as a single-hull sea truck. When there are 2 central payload modules connected together side-by-side coupled with 0˜2 fore bow modules and 1˜2 aft propulsion modules, the sea truck is known as a double-hull sea truck unit. When there are 3 central payload modules connected together side-by-side coupled with 0˜3 fore bow module(s) and 1˜3 aft propulsion module(s), the sea truck is then known as a tri-hull sea truck unit. Double-hull sea truck units, tri-hull sea truck units, and sea truck units each with more than 3 central payload modules and multiple propulsion modules are collectively known as multi-hull sea truck units. Herein, the term of “sea truck unit(s)”, or simply “sea truck(s)” (including their graphical representations as depicted in relevant figures referenced herein), is collectively used to represent both single-hull and multi-hull sea truck unit configurations without exception.

Consistent with some implementations, the bow module 108 may serve multiple purposes. For example, the bow module 108 may provide streamlining for the sea truck, increasing speed and range capabilities, and may also provide forward buoyancy to allow the sea truck to maintain an even keel in the water. In some embodiments of the design, the bow module may provide a forward mounting for potential radar and anti-collision lighting, and/or may provide a mounting for forward athwartship thrusters for increased heading control powered by an internal battery pack or other power source(s).

Consistent with some implementations, the propulsion module 112 may include a propulsion unit and controller subsystem (with associated propulsion system having steering capability). The propulsion system may be powered by a selection of stored energy systems, which may include, but are not limited to, gasoline, diesel, battery, hydrogen, fuel cell, other chemical, or even nuclear energy. The propulsion system may be fabricated for efficiency (streamlined), and agility (responsive to autonomous steering inputs integrating propulsors/propellers with thrusters to control the sea truck) having associated navigation systems, antenna, navigation lighting, communication systems and processors/software to support control commands, inventory specifics and stored/communicated commands to support the operations intended for payload module and/or any equipment associated therewith. As noted above, consistent with some embodiments, the sea truck 106 may be capable of operating individually or swarming together with other sea trucks or other maritime vessels/vehicles as a fleet or squadron. Further consistent with various embodiments, the sea truck 106 may be manned, unmanned but remotely controlled, semi-autonomous, and/or fully autonomous. Further, consistent with various embodiments, the sea truck (and/or one or more portions thereof, including, but not limited to, the bow module, the payload module, and the propulsion module) may include the addition of Radar Absorbent Materials (RAM) of the top and sides of the sea truck and/or the ability of adjusting the “freeboard” above the water surface by changing the vessel's ballast load of water, which may enhance the covert deployment and use of the sea truck.

In the example embodiment shown in FIG. 1, the aquatic support vessel is configured with rows of storage racks 102. It will be appreciated that other configurations of the storage racks may be implemented, including, but not limited to, a lesser or greater number of storage racks, greater storage rack placement, and arrangements other than a row/column arrangement. Additionally, in the illustrated embodiment, the storage racks are generally shown on the deck of the aquatic support vessel 100, for ease of illustration and understanding. In other configurations, the storage racks may be positioned in a hold of the aquatic support vessel, or in another portion of the vessel.

With continued reference to FIG. 2, the storage rack 102 may be configured to stow a plurality of the one or more modular marine vessels (e.g., sea trucks 106, generally, in the illustrated example embodiment) in a vertically stacked configuration. For example, before being launched to sea or other body of water, the aquatic support vessel 100 may have fully assembled sea truck units 106 loaded into the onboard storage racks 102. The fully assembled sea truck units 106 may be loaded into the storage racks (e.g., storage rack 102) via the gantry crane 104, shore-based cranes, cranes on adjacent vessels, cranes on adjacent sea-based platforms, or using other appropriate means. The depiction in FIG. 2 shows one sea truck 106 lifted out of the storage rack 102, generally depicting a mode of loading the storage rack 102. Consistent with the present disclosure, the storage racks (e.g., storage rack 102) may stabilize the stored sea truck units 106 during operation of the aquatic support vessel 100, e.g., during transit of the aquatic support vessel 100. As generally depicted, in some embodiments, storage rack 102 may include a rigid frame 114. Additionally, storage rack may include passive alignment features (e.g., passive alignment feature 116) that may facilitate loading and unloading modular marine vessels into and out of the storage rack 102 (e.g., by requiring less precise alignment between a crane or other mechanism handling the modular marine vessel and the storage rack).

The illustrated example embodiment shown in FIG. 2 is depicted as being configured to store modular maritime vessels (e.g., sea trucks 106) built using a 40-ft ISO shipping container as the payload module 110, and a 10-ft propulsion module 112. However, it will be appreciated that the storage rack may be configured for any possible combination of units, including, for examples, one or more 20-ft ISO intermodal containers, one or more 53-ft ISO intermodal containers, as well as various other ISO intermodal container sizes, as the payload module. Similarly, the storage rack may be configured for storing different sized bow modules 108 and different sized propulsion modules 112. Additionally, while the depicted embodiment is shown implemented with sea trucks based around ISO standard intermodal containers, as noted above the storage rack may be configured for use with other types of modular marine vessels. Additionally, while the embodiment of the storage rack depicted in FIG. 2 is shown as being sized to store three sea truck units, the storage rack may be configured to more or fewer modular marine vessels.

Consistent with various embodiments, the storage rack 102 may include various systems and/or features that may be configured to monitor and/or maintain the operability of the sea truck units while they are stored. For example, the storage rack 102 and/or another system adjacent to the storage rack, may include a charging system configured to charge one or more batteries associated with one or more modular marine vessels within the storage rack [e.g., (1) inductive, plug, contact charging; (2) charging individual components, or charging the sea truck generally with power distributed by sea truck to components; (3) similar or different charging system(s) for component storage racks; and/or (4) cooling system for thermal management during charging]. As generally discussed above, the sea truck 106 may include various systems that may be battery powered. Accordingly, the storage rack 102 may include a charging system configured to charge one or more batteries within the sea truck 106. According to an example embodiment, the charging system may be configured to charge batteries onboard electronic embodiments of the sea truck bow module 108, and propulsion module 112 through sets of induction coils (e.g., induction coil 118 arranged to charge batteries associated with the propulsion module 112 of the top sea truck in the storage rack, with similar induction coils arranged to charge other sea trucks stacked in the storage rack, as well as at the other end of the storage rack for charging batteries associated with bow modules 108 of the sea trucks). To facilitate this efficient charging methodology, sea truck units may be equipped with battery adapter modules (e.g., battery adapter module 120 shown in FIG. 2) that may include the mating induction coils to couple with the storage rack charging coils 118. Consistent with such a configuration, batteries associated with the sea truck units (e.g., associated with the bow modules and/or propulsion modules) may be charged without requiring direct contact. Consistent with some implementations, the battery adapter module 120 may provide a consistent internal induction coil to enable charging with the storage rack 102, which may have a complementary induction coil powered from the aquatic support vessel. In some implementations, the adapter may offer a versatile internal induction coil interface to enable the usage of any viable battery to power sea truck modules. It should be noted that the cooperating inductive coils may be arranged to be closer or farther apart, and that the illustrated depiction is intended for clarity. It will be appreciated that while the charger may utilize inductive charging, other charging interfaces may also be utilized, e.g., including but not limited to, electrical contacts associated with the storage rack that may contact corresponding electrical contacts associated with the modular marine vessels. Additionally, while the inductive coils are shown positioned for interfacing with corresponding inductive coils of the bow module and/or propulsion module, charging interfaces (inductive or contact) may be arranged for providing a charging interface associated with the payload module.

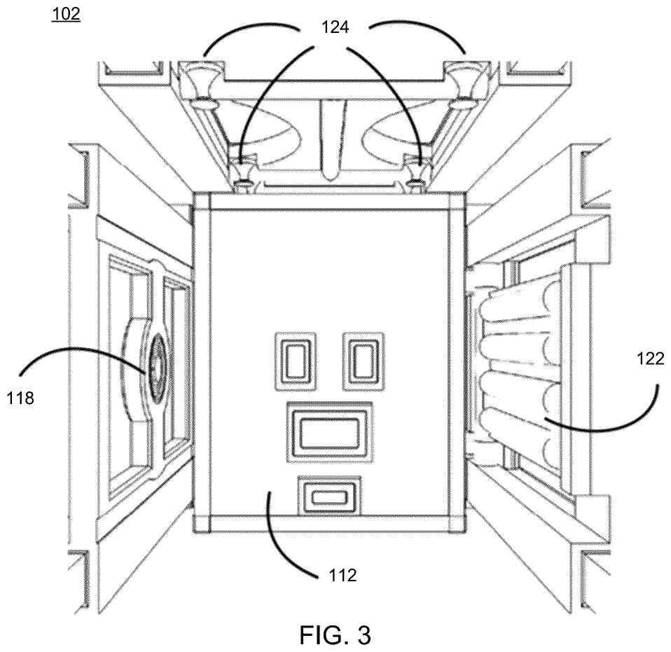

In some example embodiments, the battery adapter module (e.g., battery adapter module 120 associated with propulsion module 112, and/or a battery adapter module associated with the bow module 108) may include cooling plates, e.g., that may be hooked up either to the unit's bilge pump system, ballast tank input, or thruster transfer pipe to allow for constant cooling while at sea during maximum discharge operations. Similarly, onboard cooling pads 122 (shown in e.g., FIG. 3) may be associated with storage rack 102. Onboard cooling pads 122 may be utilized to improve the heat dissipation capabilities of the stored modular maritime vessels (e.g., sea truck 106) through direct contact heat transfer with the storage rack 102 during charging of the batteries. In some embodiments consistent with the present disclosure, an internal interface of the battery adapter module 120 may have unique structures to support differing batteries, cool differing batteries and charge differing batteries.

According to some embodiments, the aquatic support vessel 100 may further include a fire control system associated with the storage rack. The fire control system may include various fire suppression systems (e.g., sprinklers, fire suppression foam nozzles, fire and/or smoke detection systems, and the like). For example, as shown in FIG. 3, the aquatic support vessel 100 may include onboard ship fire fighting nozzles 124 arranged relative to the storage rack 102 to extinguish flames and mitigate the risk of electrical shorts/heat causing damage to surrounding sea truck units. It will be appreciated that, for simplicity of illustration, the embodiment shown in FIG. 3 is depicted including the induction coils 118, the cooling pads 122, and the fire-fighting nozzles 124 on discrete sides of the storage rack enclosure 102. However, it will be appreciated that other embodiments and configurations of the storage rack design may include different positioning of these components to maximize functional contact with the stored modular maritime vessels. Similarly, other embodiments of the storage rack may include additional support features to facilitate the use of alternative/hybrid power sources (e.g., hydrogen fuel cells with hydrogen storage devices to generate electricity or electrical generators run by internal combustion engines with petroleum product storage devices to automatically charge the batteries) to power the Sea Truck units.

The aquatic support vessel 100 may, in some embodiments consistent with the present disclosure, include a communication system configured to communicate with one or more modular marine vessels. For example, and with continued reference to FIG. 2, storage rack 102 includes a communication module (e.g., communication module 126). It will be appreciated that the location and positioning of communication module 126 relative to the storage rack 102 is for illustrative purposes, as the communication module may be positioned in a variety of locations. Additionally, while communication module 126 is shown specifically associated with the storage rack 102, it will be appreciated a discrete communication module may be provided with each individual storage rack, each individual modular maritime vessel in each storage rack, and/or a single communication module may service multiple storage racks, including a single communication module servicing the entire aquatic support vessel.

The communication module 126 may perform a variety of functions. For example, communication module 126 may monitor the status of each onboard modular marine vessel (e.g., sea truck unit 106) and to relay that information to the aquatic support vessel 100 and/or another vessel, a land-based control center, an aerial support vehicle and/or a tele-communication satellite to ensure readiness for successive deployments of the modular marine vessels. Monitoring the status of one or more modular marine vessels may include determining the status of the one or more modular marine vessels (including, but not limited to, a status of the modular marine vessel, the status of a bow module, the status of a propulsion module, the status of one or more systems carried by and/or operated by the modular marine vessel, etc.). In one particular embodiment, the communication module 126 may network with the stored bow module 108 and propulsion module 112 to execute any needed automatic diagnostics [e.g., battery state, thruster operations, environmental parameters (e.g., air/water temperature, humidity, bilge water levels, etc.), communications, mission upload, and safety radar checks, any indication of damage or fault] and to provide instructions to the one or more modular marine vessels (e.g., preload operational instructions, including, but not limited to, steering directions, cargo descriptions, swarming coordination, etc.). The communication system may perform various additional and/or alternative functions. For example, the communication system may communicate with one or more modular marine vessel to identify specific modular marine vessels in the storage rack(s), determine a configuration of one or more of the modular marine vessels (e.g., which bow module and/or propulsion module is connected to which payload module; and which mission package is uploaded to the payload module of which sea truck or marine vessel).

Continuing with the foregoing, the aquatic support vessel may include an inventory control system, e.g., configured to identify the various modular marine vessels onboard (e.g., including the number of modular marine vessels contained within the various storage racks, as well as which storage rack individual modular marine vessels are stored in, and what position within a storage rack an individual modular marine vessels is stored), as well as the configurations of the various modular marine vessels (e.g., which bow modules and/or propulsion modules are connection to which payload modules). Consistent with an example embodiment, the communication module 126 may include RFID reader that may obtain information from RFID chip sets associated with the various modules of the various modular marine vessels. Accordingly, the communication system may be able to keep an inventory of all of the modules onboard the aquatic support vessel, the locations and configurations of all of the modules and modular marine vessels, as well as various status information, as generally discussed above. It will be appreciated that the inventory control system may be separate from the communication system. Additionally, the inventory control system may utilize technologies other than RFID. For example, the inventor control system may utilize bidirectional wireless communication, optical monitoring of, e.g., barcodes, QR codes, etc. associated with various modules. Various additional and/or alternative systems may similarly be implemented.

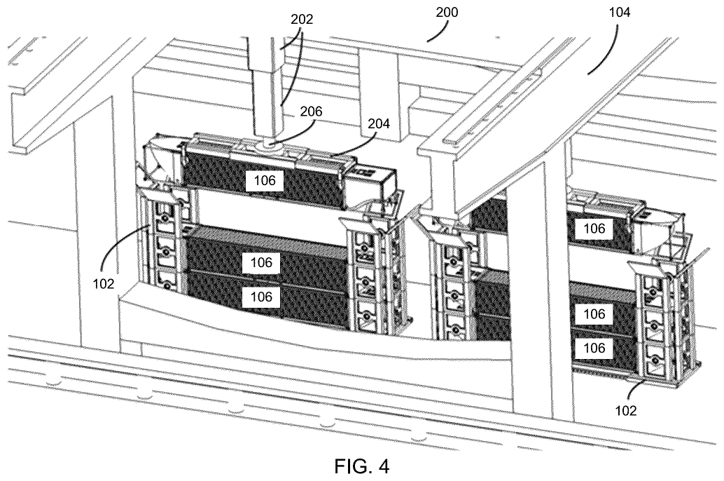

As generally discussed above, the aquatic support vessel (e.g., aquatic support vessel 100) may include a gantry crane (e.g., gantry crane 104) having rigid, extendable column configured for lifting one or more of the modular marine vessels out of the storage rack and/or placing one or more of the modular marine vessels into the storage rack. With additional references to FIGS. 4-6, example embodiments of the gantry crane and operations thereof are generally shown. Consistent with the illustrated example embodiment, gantry crane 104 may include trolley 200, which may include an extendable column (e.g., extendable column 202). While only a single trolley is depicted, this is for clarity of illustration and explanation, as the gantry crane may include multiple trollies. The trolley 200 may allow the extendable column 202 to move laterally about the gantry crane 104. For example, and referring back to FIG. 1, the gantry crane 104 may be generally arranged athwartship of the aquatic support vessel 100. Accordingly, the trolly 200 may allow the extendable column 202 to be moved and/or positioned laterally across the beam of the aquatic support vessel. Additionally, in some embodiments the gantry crane 104 may be configured to move and/or be positioned longitudinally about the length of the aquatic support vessel 100. For example, the gantry crane may ride on tracks or guides extending along at least a portion of the length of the aquatic support vessel. Accordingly, the gantry crane may move about the length of the aquatic support vessel and the trolley may move laterally on the gantry crane. As such, the extendable column may be moved and/or positioned both about the length of the aquatic support vessel and about the width of the aquatic support vessel.

As shown in the illustrated example embodiment of FIGS. 4-6, the extendable column 202 may include a generally rigid telescoping arrangement. The rigid extendable column may mitigate any pendulosity or oscillation of cargo (such as the modular marine vessels) during lifting, as is experienced with traditional cable-based crane systems. The mitigation of pendulosity or oscillation of cargo during lifting may be particularly advantageous during rough sea states and/or unsettled weather conditions. In the illustrated example embodiment, the extendable column 202 is shown as a telescoping feature, however, it will be appreciated that other rigid extendable arrangements may be implemented. For example, the rigid extendable column may include a scissor mechanism, adjacent sliding members, nested sliding members, and the like.

Continuing with the example implementation depicted in FIGS. 4-6, once the aquatic support vessel 100 reaches its desired deployment positioning, the sea trucks 106 may be launched by way of a gantry crane 104. The aquatic support vessel 100 (e.g., control systems thereof and/or remote control input) may move the gantry crane 104 into a position above a set of sea trucks 106 that are ready for deployment. According to one implementation consistent with the present disclosure, the gantry crane 104 may include a trolley 200 having at least a first extendable column and a second extendable column (e.g., extendable columns 202 shown in FIGS. 4-6). Each of the first extendable column and the second extendable column (e.g., depicted extendable columns 202) may be configured for lifting a respective one of the one or more of the modular marine vessels (e.g., sea trucks 106) out of the storage rack or placing a respective one of the one or more of the modular marine vessels into the storage rack. As shown in the illustrated example embodiment, the aquatic support vessel 100 may include a plurality of storage racks 102, including at least a first storage rack and a second storage rack. The first extendable column may be configured for lifting one of the one or more modular marine vessels from the first storage rack and placing one of the one or more modular marine vessels into the first storage rack. Similarly, the second extendable column may be configured for lifting one of the one or more modular marine vessels from the second storage rack and placing one of the one or more modular marine vessels into the second storage rack. Accordingly, in some embodiments, the first and second extendable columns may be configured to lift a respective one of the one or more modular marine vessels from the first storage rack and the second storage rack and to place a respective one of the one or more modular marine vessels into the first storage rack and the second storage rack without repositioning the trolly of the gantry crane. It will be appreciated that in some embodiments, the gantry crane and/or each trolley of the gantry crane, may include more than two rigid extendable columns.

Consistent with the foregoing, and according to an example embodiment, the storage racks 102 stowing the modular marine vessels (e.g., sea trucks 106) may be spaced evenly to enable the usage of each of the gantry trollies 200 with each of them having two discrete connection points (e.g., including and/or associated with a respective rigid extendable column). Once the gantry crane 104 and at least one trolley 200 may be aligned with the stowage racks 102 beneath each of the two rigid extendable columns, each of the two spreaders 204 may be attached to a respective sea truck 106 by extending each respective rigid extendable column 202. The spreaders 204 may generally include an arrangement for grasping and/or attaching to the modular marine vessels 106. In an implementation in which at least a portion of modular marine vessel utilizes an ISO standard intermodal container form factor, the spreaders may include any variety of container spreaders. As is generally known, a container spreader is used for lifting shipping containers (such as ISO standard intermodal shipping containers) and provides a connection between lifting equipment and a container being lifted. A variety of different spreader configurations are known and may be utilized in connection with the present disclosure. For example, some spreader configurations may include locking mechanisms at each corner that may attach to the four corners of the container (e.g., utilizing the standard intermodal container twistlock connectors). Other spreader configurations may also suitably be employed.

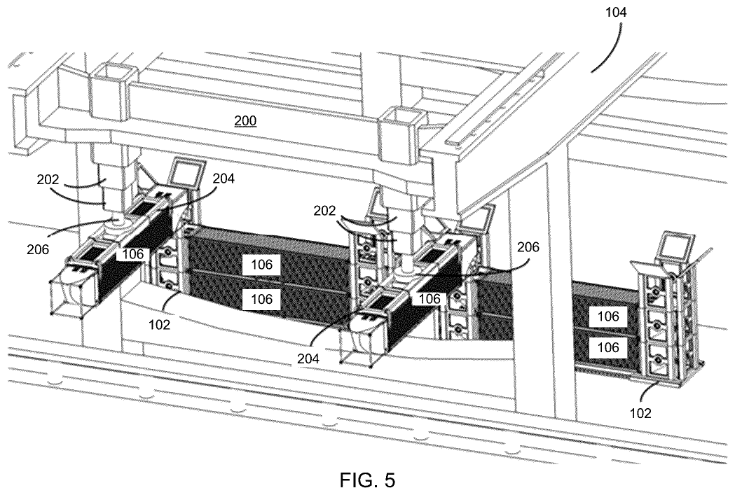

Once the spreaders 204 are connected to a respective modular marine vessel (e.g., sea truck 106 in the illustrated embodiment) the respective sea trucks 106 may be lifted. An example lifting sequence utilizing the gantry crane 104 is generally depicted in FIGS. 4-6. As generally shown, the gantry crane 104 may be moved to position a respective extendable column 202 and spreader 204 arrangement over a respective storage rack 102 and the spreaders 204 may connect to two discrete sea trucks 106. In the depicted embodiment, the spreaders 204 may connect to two respective sea trucks 106 that are aligned in opposite directions on the same line. It will be appreciated that other configurations may be implemented. For example, the gantry crane may be configured to retrieve respective sea trucks 106 that are oriented in a side-by-side arrangement, which may, in some implementations, simplify the stowage alignment within the aquatic support vessel's hold. After lifting, the spreaders 204 may be rotated 90 degrees using a rotating linkage 206. The rotating linkage 206 may include any suitable rotatable assembly that may allow the spreaders 204 (as well as any modular marine vessel connected via the spreaders) to be rotated relative to the gantry crane 104. While the rotating linkage is depicted as being an assembly at the distal end of the rigid extendable column, in other configurations the rotating linkage may be integrated into the rigid extendable column, and/or may be disposed between the rigid extendable column and the trolley of the gantry crane. Additional arrangements may also suitably be utilized. The rotation of the rotating linkage 206 may, in some implementations, permit the sea trucks to be maneuvered between the support legs of the gantry crane 104, which may be configured with a sufficient width to enable this movement. In some implementations, the required width for maneuvering the sea trucks between the support legs of the gantry crane may be reduced through the use of a side-by-side lifting configuration, as generally described above. This rotation process is shown in FIG. 5.

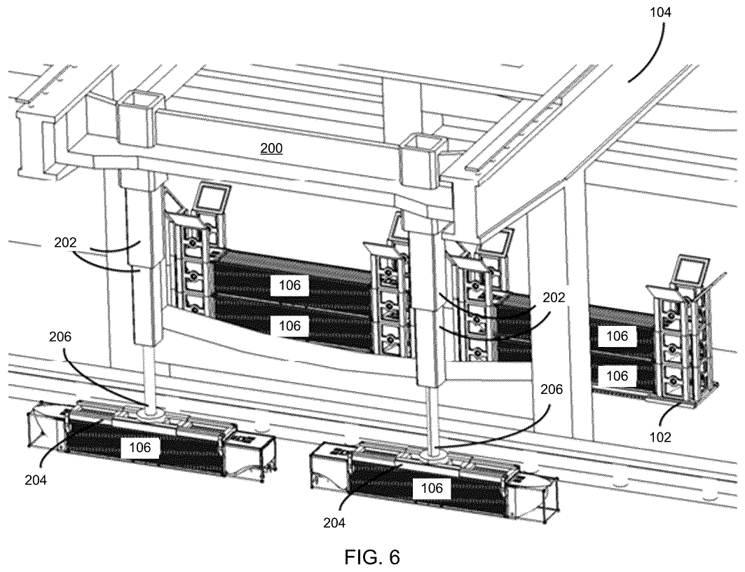

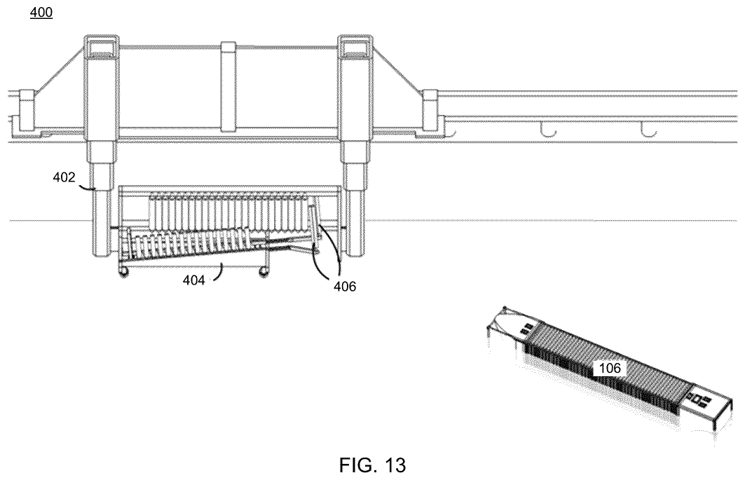

After the trolley 200 clears the outboard crane support, the spreaders 204 may be rotated back 90 degrees and the sea trucks may be lowered parallel to the aquatic support vessel's hull and onto the sea surface for deployment by a gradual water-displacement method to reduce effective plunging forces acting by the body of water on the sea truck units. The lowering process, consistent with an example embodiment, is depicted in FIG. 6. Additionally, FIG. 6 shows an example embodiment of an implementation for simultaneously deploying two sea trucks 106. Consistent with the example embodiment, when sea trucks 106 may be launched simultaneously from the same side of the aquatic support vessel, the sea trucks 106 may be oriented in opposite directions to mitigate the risk of suction forces from the water stream passing between two closely spaced, moving parallel vessels on the water surface, which may tend to pull the sea truck units together after launch. According to some embodiments, a process for retrieval of deployed sea trucks from the water may occur in general the reverse of the process outlined in FIGS. 4-6. For example, according to such a process the deployed sea truck(s) may align parallel to the body of the aquatic support vessel 100 to permit the gantry crane 104 to overhang the side of the aquatic support vessel 100 and connect to the sea truck(s) through the deployable spreaders 204. Additional example retrieval processes are contemplated, and are discussed in greater detail below, with reference to FIGS. 13 through 19.

In addition to including arrangements to store fully assembled modular marine vessels (e.g., storage rack 102), according to some example embodiments the aquatic support vessel may additionally include the facility to assemble modular marine vessels, reconfigure modular marine vessels, and/or repair modular marine vessel. For example, in some implementations consistent with the present disclosure the aquatic support vessel may further include one or more of: a replacement rack configured to stow one or more spare module components for the modular marine vessels, and a removed component rack configured to stow one or more module components removed from the modular marine vessels.

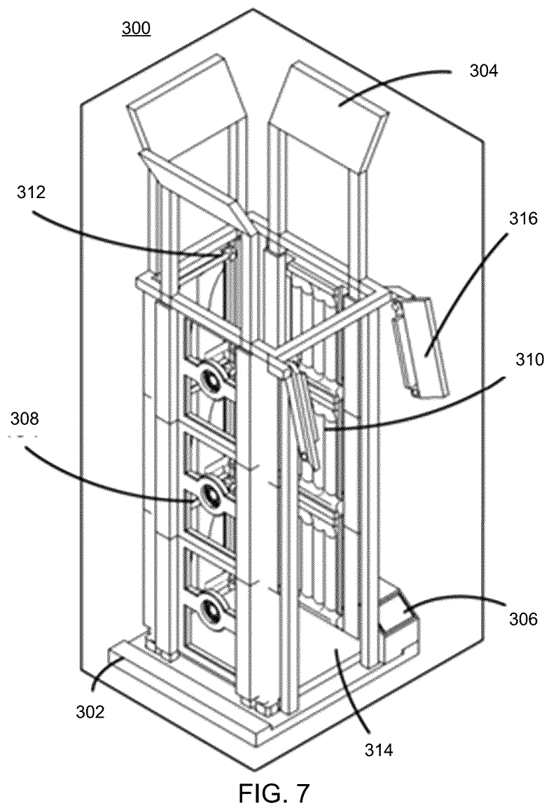

For example, during regular operation after launch and retrieval of the modular marine vessels, the onboard bow modules (e.g., bow module 108) and propulsion modules (e.g., propulsion module 112) may experience wear and/or damage. With additional reference to FIG. 7, in the event that a retrieved module of a modular marine vessel experience failures and/or are damaged beyond the point of functioning and/or useful intended operation, the aquatic support vessel 100 may be equipped with one or more unique replacement racks (e.g., replacement rack 300). Replacement rack 300 may store components that may be employed to substitute broken modules (and/or modules that are otherwise desired to be replaced) with functional spares/replacement modules. In a generally similar manner as storage rack 102, the unique replacement rack 300 may include a rigid frame 302, which may, in some embodiments, include one or more passive alignment features 304. The replacement racks may include communication units 306 to monitor the status of the stored spare modules, induction coils 308 to charge spares, cooling pads 310 to improve heat dissipation, and fire-fighting nozzles 312. Communication units 306, induction coils 308, cooling pads 310, and fire-fighting nozzles 312 may perform similar functions, and include similar variations as discussed with regard to the corresponding features associated with the storage rack 102, all of which are incorporated herein. Consistent with some implementations, the replacement racks 300 may also include a liftable platform 314 that can shift a stored stack of modules downward to make room for another spare being loaded on top of the stack of modules. For example, in some embodiments, one or more modules stored in the replacement rack 300 may rest on the lifting platform 314, which may be positioned within the replacement rack to index a top-most module adjacent the top of the rack. In the event that another module is to be added to the replacement rack, the lifting platform may be lowered to create room at the top of the replacement rack to receive the module to be added. Similarly, the lifting platform may be raised to position the upper-most module in the replacement rack adjacent to the top of the replacement rack, e.g., for attachment to a modular marine vessel, as will be described in greater detail below. Additionally, consistent with some embodiments, the replacement rack 300 may include one or more alignment features for aligning a stowed spare module component within the replacement rack with a payload component of one or more modular marine vessels for assembling the stowed spare module component with the payload component. In an example embodiment, the one or more alignment features may include a deployable mechanical perch 316 that provides an alignment surface for incoming sea trucks 106 being brought into alignment with the replacement rack 300 by movement of the gantry crane 104.

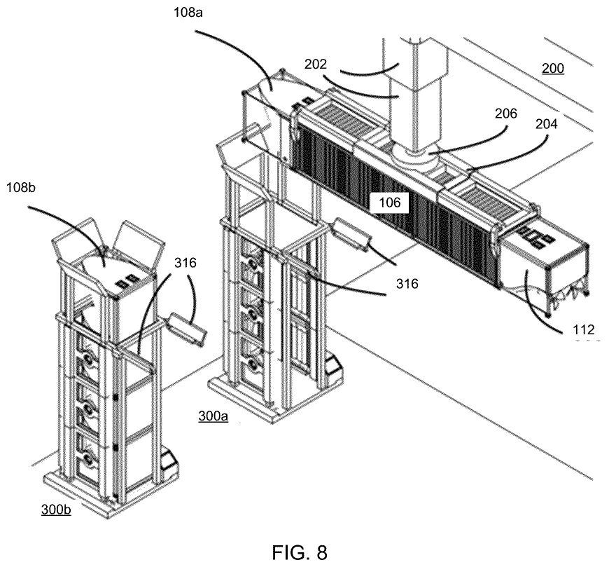

In an example embodiment, the replacement rack 300 may be utilized for assembling one or more modular marine vessels, repairing one or more modular marine vessels, and/or reconfiguring one or more modular marine vessels. For example, in the context of repairing a modular marine vessel (e.g., a sea truck 106), after retrieval of the sea truck, if any damage to the bow module 108 or the propulsion module 112 is diagnosed (e.g., during any automatic checks, or other forms of diagnostic), a replacement procedure may be initiated. Examples of diagnosed damage to a bow module may include hull damage detected by, e.g., excessive onboard bilge pump run time, onboard thruster low performance, or low battery voltage range or performance. One illustrative example repair/replacement procedure for a bow module is generally depicted with reference to FIGS. 8 through 11. Once damage is diagnosed (and/or replacement of a bow module attached to a modular marine vessel is desired, e.g., as part of a reconfiguration procedure), a sea truck 106 with a damaged module 108a may be maneuvered, e.g., using the gantry crane 104, to a position generally above a replacement rack 300a. Replacement rack 300a may be selected based on replacement rack 300a having sufficient space, or capacity, to store an additional module component (e.g., bow module 108a in the depicted embodiment). In this implementation, replacement rack 300a may be considered a removed component rack. In some implementations, the difference between a removed component rack and a replacement rack may be the intended use. Consistent with the illustrated example embodiment, mechanical perches 316 may be deployed to facilitate the alignment of the Sea Truck. Consistent with an example embodiment, the mechanical perches 316 may provide an indexing or alignment feature that may align a modular marine vessel (assembled or at least partially disassembled) relative to the replacement rack such that modules may be offloaded into a removed component rack, or attached from a replacement rack. As such, the mechanical perches may facilitate alignment of the modular marine vessel (or portion thereof) with the replacement rack.

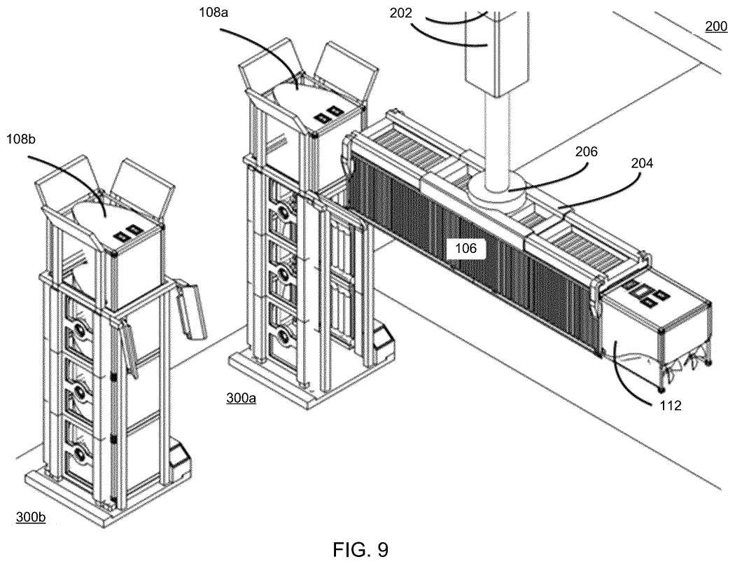

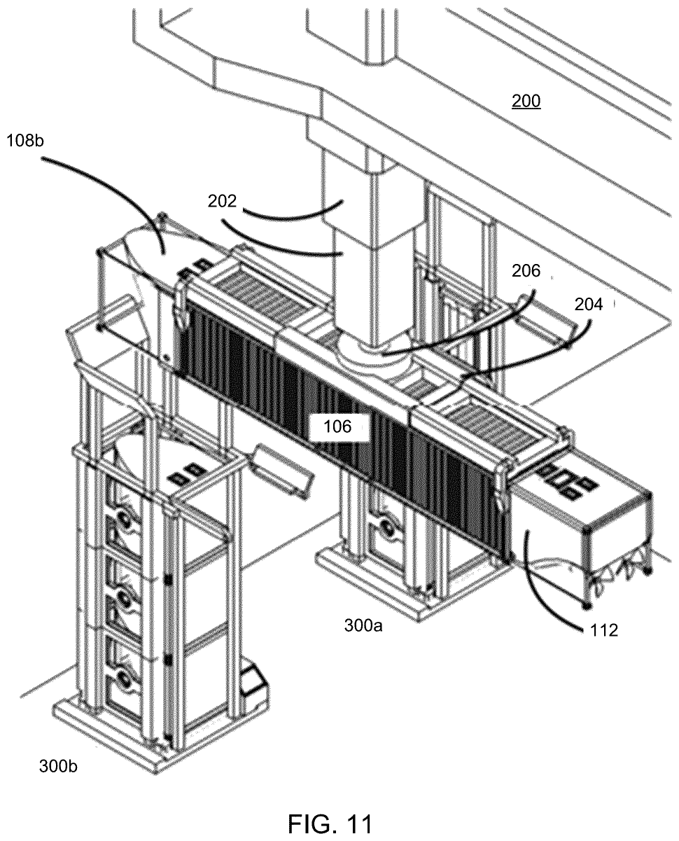

With particular reference to FIG. 8, once the mechanical perches 316 have been deployed, the gantry crane may be configured to position the modular marine vessel (e.g., sea truck 106) relative to the replacement rack 300a. For example, gantry crane 104 may lower the sea truck 104 onto the mechanical perches 316 with the bow module 108a positioned in the replacement rack 300a. Referring also to FIG. 9, the removed bow module 108a may be retained by rack 300a, and the bow module 108a may be removed from the sea truck 106 (e.g., as by disconnection ISO standard twistlock connectors, and/or otherwise disconnecting the bow module 108a from the sea truck). The removed bow module 108a may be stored in rack 300a, e.g., as by being lowered on lifting platform 314 to make room for additional components to be stored in rack 300a, as generally shown in FIG. 11.

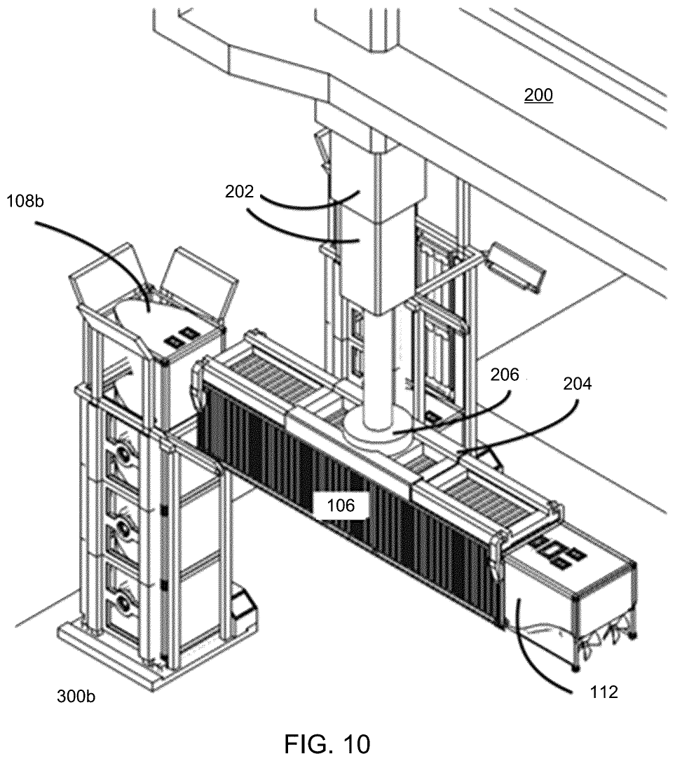

With reference to FIG. 10, once the bow module 108a has been disconnected from the sea truck 106 and, the gantry crane 104 may then be configured to position the modular marine vessel (e.g., sea truck 106) by maneuvering sea truck 106 adjacent the replacement rack 300b, which may store replacement bow module 108b. In a similar manner as positioning the sea truck 106 adjacent rack 300a, rack 300b may include mechanical perches 316 to facilitate alignment and/or support of the sea truck 106 for attachment of replacement bow module 108b. The use of mechanical perches 316 may be particularly useful, e.g., during elevated sea states and/or under inclement weather conditions. The replacement bow module 108b may be secured to the sea truck 106, e.g., using ISO standard twislock features, or other connectors. With the replacement bow module 108b attached to the sea truck 106, the sea truck 106 may be lifted away from rack 300b, as shown in FIG. 11, and may be stored in a storage rack 102, maneuvered for attachment or replacement of other component modules, and/or redeployed. While the foregoing description relates to the removal/replacement of a bow module, a corresponding process may be implemented to remove and/or replace other components of the modular marine vessel, such as a propulsion module. Additionally, similar processes may be implemented to reconfigure an already (at least partially) assembled modular marine vessel, and/or to assembly a modular marine vessel from component part.

Consistent with some implementations, the aquatic support vessel may further include a retrieval system. For example, without aid, the difficulty of positioning two returning modular marine vessels simultaneously for retrieval may restrict the recovery process to one modular marine vessel at a time with each of the extendable columns and spreaders on the gantry crane. In some implementations, the aquatic support vessel design may be specifically biased towards a rapid offload of the modular maritime vessels. For example, it may be the case that during most military and disaster relief scenarios the ability to rapidly offload supplies may be much more critical than recovery empty or shore-based returning modular marine vessels. However, according to some implementations, the aquatic support vessel may include one or more retrieval systems to decrease retrieval complexity and increase retrieval rate.

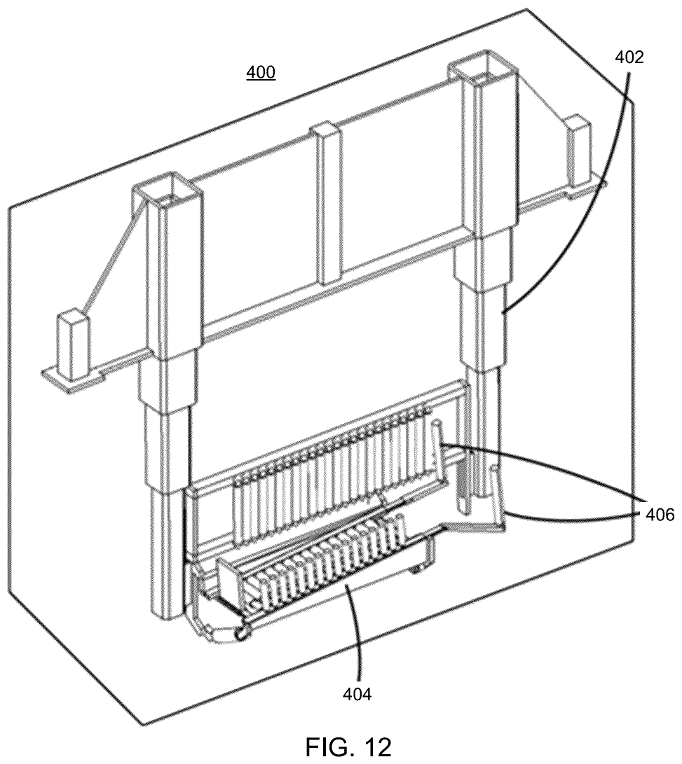

Referring also to FIGS. 12-16 an illustrative example embodiment of one retrieval system 400 is shown, which may be termed and “in situ retrieval system.” The in-situ retrieval system 400 may generally include a retrieval platform deployable over a side of the aquatic support vessel 100 to a position at least partially below a surrounding water surface to enable one or more of the modular marine vessels to navigate one or more of onto and above the retrieval platform. For example, the in situ retrieval system 400 may include an extensible constant lift force structure 402 that connects the structure to the hull of the aquatic support vessel 100. Employment of a constant lift force mechanism may decrease the risk of motion of the modular marine vessels (e.g., sea truck 106) induced by wave actions causing the sea truck 106 to impact the lifting structure resulting in damage to the retrieval structure and/or the sea truck units currently contained within the system. The extensible structure 402 may overhang the edges of the deck of the aquatic support vessel and may deploy downwards towards the water surface.

According to some embodiments, the retrieval system may include a retrieval platform deployable over a side of the aquatic support vessel to a position at least partially below a surrounding water surface to enable one or more of the modular marine vessels to navigate one or more of onto and above the retrieval platform. For example, and continuing with the illustrative example embodiment of FIGS. 12-16, a deployable platform 404 that can be rotated, for example, 90 degrees from a first stowed position oriented generally parallel with side of the aquatic support vessel 100 to a second position generally parallel with the surrounding water surface. In some implementations, the first stowed position may be a generally vertical position, which may be utilized during transit of the aquatic support vessel. In some implementations, the second deployed position may be a generally flat/horizontal orientation almost parallel to the water surface. In some embodiments, in the deployed position the platform 404 may be oriented at a slight angle, lengthwise, relative to a horizontal plane to aid in securing a modular marine vessel that navigates onto the platform 404. According to some embodiments, the width and length of the platform 404 may be variable (i.e., automatically extended and retracted) to permit the retrieval of modular marine vessels of a variety of size configurations and lengths. The retrieval system 400 may also include one or more bollards (e.g., bollards 406) that may, in some embodiments, extend from the front of the platform 404 to aid in guiding the modular marine vessels onto the retrieval platform 404. In some implementations, one or more similar rolling guides may be placed on all surrounding surfaces of the platform 404, which may streamline the motion of incoming modular marine vessels as they maneuver into position for retrieval. As such, the one or more bollards may facilitate navigation of the one or more modular marine vessels to navigate to a desired position with respect to the retrieval platform.

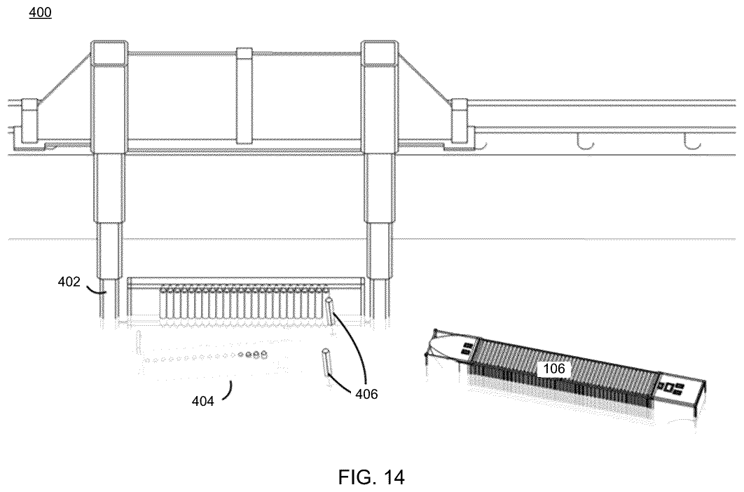

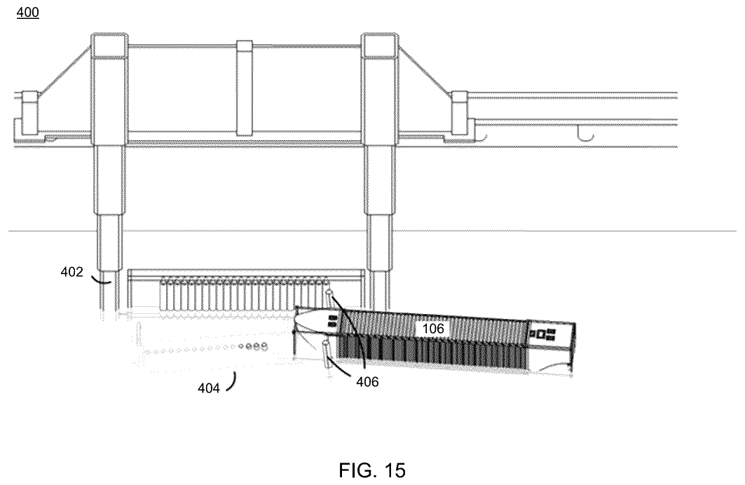

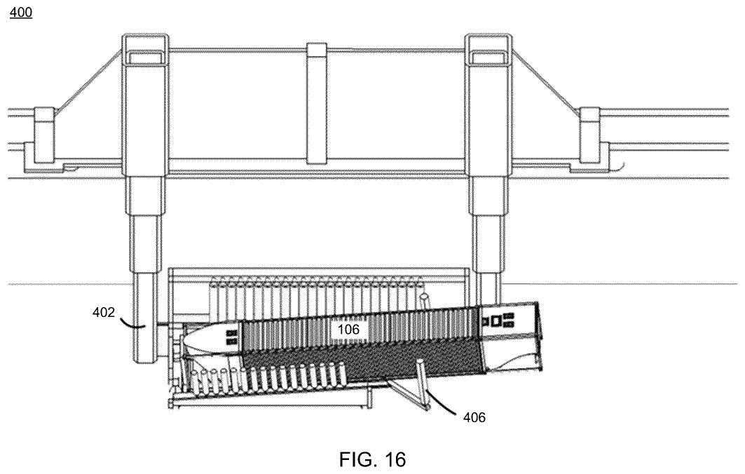

With particular references to FIGS. 13-16, an illustrative example retrieval process utilizing the in-situ retrieval system 400 is shown. Referring to FIG. 13, the retrieval system 400 may initially be in a retracted state, with the retrieval platform 404 folded into the stowed, generally vertical position, and the extensible constant lift force mechanism 402 may be in a raised position. With further reference to FIG. 14, the deployable platform 404 may be rotated to be in a deployed, generally horizontal retrieval position, and the extensible constant lift force mechanism 402 may be lowered to position the platform 404 slightly beneath the surface of the water. Consistent with some embodiments, as needed, the height of the platform 404 may be synchronized, e.g., utilizing data from a gyro aboard the aquatic support vessel 100 to decrease further the risk of modular marine vessel damage due to excessive aquatic marine vessel motion by sensing the aquatic support vessel's motions and the waves heights and the wave crests, which may thereby lessen the differences to lower impact forces between them until the modular marine vessel is fully supported by the retrieval structure and not supported by water displacement. As shown in FIG. 15, an approaching modular marine vessel (e.g., sea truck 106) may be maneuvering to a retrieval position. This process may be aided using the bollards 406, which may provide contact points to decrease the navigational challenge posed by maneuvering the sea truck 106 into position. With addition reference to FIG. 16, once the sea truck 106 has reached a secured position atop the retrieval platform 404, the extensible constant lift force mechanism 402 may lift the sea truck 106 back up to the deck of the aquatic support vessel.

Consistent with some implementations, the retrieval system shown and described with respect to FIGS. 12 through 16 may be remotely controlled and/or autonomous and may be capable of operating independently of, or in tandem with the gantry crane 104. The gantry crane system 104 on board the aquatic support vessel 100 (or other suitable crane systems on board of any water vessels/military ships, on offshore platforms or on land) combined with the proposed hull-mounted in-situ retrieval platform system 400 (whether very small or very big) may easily accomplish robust rapid transfer of payloads/mission packages (a) from sea to sea (or from skin to skin of two different vessels/platforms), (b) from shore to sea, (c) from sea to shore, and/or (d) from shore to shore via the water route in an unmanned/autonomous fashion without subjecting personnel to harm's way and in anti-access and access-denial (A2/AD) zones, while cost-effectively solving the dilemmas preventing traditional and/or articulating cranes from reliably retrieving a Sea Truck or other water vessels from dynamically changing water surfaces.

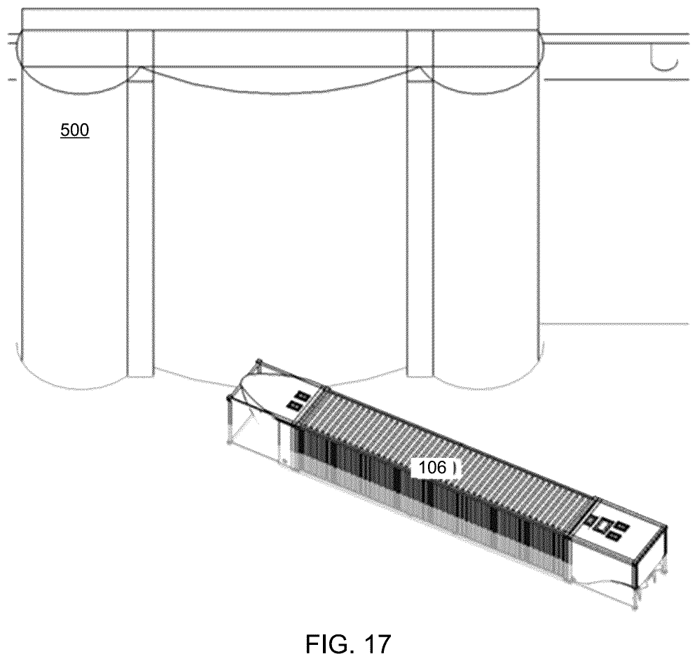

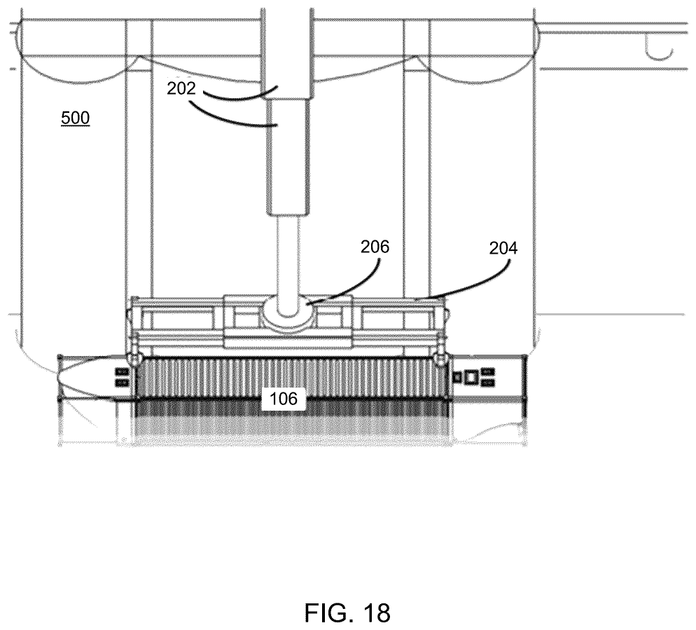

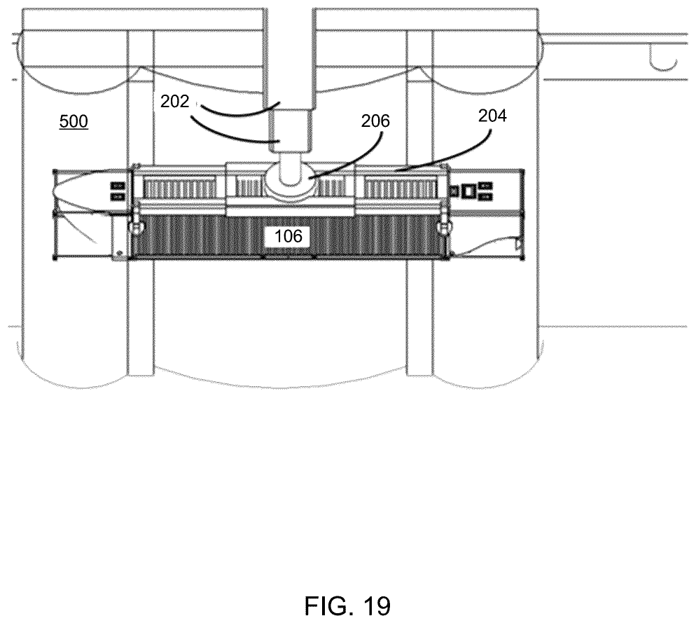

In addition/as an alternative to the in-situ retrieval system, the aquatic support vessel may utilize additional systems for recovering modular marine vessels from the water. For example, another embodiment of a retrieval system may rely on contact to overcome alignment challenges. Referring also to FIGS. 17-19, according to one such implementation, the aquatic support vessel 100 may include one or more cushioned bollards 500 that are either deployable over a side of the aquatic support vessel 100 and/or affixed to the side of the aquatic support vessel 100 to a position at or below a surrounding water surface. As shown in FIG. 17, a returning modular marine vessel (e.g., sea truck 106) may collide with the bollard system 500, which may be sufficiently padded to mitigate any risk of damage with the bow of the truck, to begin its alignment with the orientation of the aquatic support vessel 100. The sea truck 106 may then utilize sustained and/or intermittent low-powered propulsion and directional stability through the coordinated use of the sea truck thrusters, align itself parallel to the hull of the aquatic support vessel. This alignment may enable the gantry crane to deploy its designated spreader 204 by way of one of its rigid extendable columns 202 to catch and collect the sea truck unit. Any additional rotational variance may be accounted for by the rotating linkage 206, as generally shown in FIG. 18. Once the sea truck 106 has been secured by the spreader 204, the spreader 204 may be used to lift the collected sea truck 106 out of the water, as shown in FIG. 19. The gantry crane may thus be configured to retrieve the modular maritime vessel from the generally parallel orientation against the side of the aquatic support vessel 100. Once recovered, the gantry crane may be utilized to reposition the modular marine vessel for further stowage or repairs on the deck of the aquatic support vessel, as generally previously described.

Consistent with some embodiments, the present disclosure may generally provide systems and processes that may allow modular marine vessels to be assembled, disassembled, stores, maintained/repaired/serviced, released to and collected from a body of water without relying on dockside amenities such as shore-to-ship, ship-to-shore, and/or water-based cranes. The deployed modular maritime vessels may be capable of acting either independently or as part of a swarm/fleet, and may be capable of conducting distributed, discreet, and efficient tasks before returning to the aquatic support vessel for recharging and relaunching. According to some implementations, eliminating the need for modular marine vessels to be launched from or retrieved from a conventional dock may substantially increase the effective range of the modular marine vessels, while also providing new strategies to accomplish covert, strategic/tactical operations, aid with emergency responses, and deliver goods.

Consistent with some embodiments, an aquatic support vessel may include modified gantry crane(s) having a modified trolley design that may include extendable column structures. In some embodiments, the modified trolley design may include adjacent extendable column structures in either a parallel or side-by-side arrangement to manipulate, grasp, or release multiple containers or modular marine vessels (including both single-hull and multi-hull modular marine vessel configurations and of differing lengths) in a single movement operation passing through the crane support columns or rotating to facilitate movement over the ship's hull for water deployment or retrieval.

Consistent with some embodiments, an aquatic support vessel may include a storage rack of a multi-rack system that may permit the vertical stacking of modular marine vessels (including single-hull and multi-hull modular marine vessel configurations and differing lengths) by way of overhead gantry crane(s). The storage rack system may include features to locate and protect stowed modular marine vessels (including single-hull and multi-hull modular marine vessel configurations and of differing lengths) during movement of the rack without damage to the stowed vessels.

Consistent with some embodiments, a storage rack may include an onboard communication module that may transmit information on the position, number of containers, and operability/launch status of stowed modular marine vessels (including single-hull and multi-hull modular marine vessel configurations and of differing lengths). In some embodiment, the communication module and/or associated systems may contain cargo descriptions for each container and may be capable of communicating with each modular marine vessel individually to provide planned mission guidance (course, delivery location, and time of arrival).

Consistent with some embodiments, a storage rack may include induction coils that be configured to charge each stowed modular marine vessel (including single-hull and multi-hull modular marine vessel configurations and of differing lengths) by way of a cooperating induction coils. In some embodiments, the induction coils may be configured to keep the modular marine vessels charged in preparation for subsequent operations.

Consistent with some embodiments, the storage rack may include external cooling pads and fire-fighting nozzles to control the temperature of stowed modular marine vessels (including single-hull and multi-hull modular marine vessel configurations and of differing lengths) and prevent damage due to electrical shorts/heat.

Consistent with some embodiments, a battery adapter unit(s) may be inserted into the battery housing(s) of a modular marine vessel (including single-hull and multi-hull modular marine vessel configurations and of differing lengths) to permit the use of any type of battery to power the modular marine vessels (including single-hull and multi-hull modular marine vessel configurations and of differing lengths). The adapter unit may include structures internal to a modular marine vessel bow or stern module that connect to, cool, and charge varying batteries while maintaining a similar and/or identical external interface design to facilitate charging by way of the systems herein.

Consistent with some embodiments, an aquatic support vessel may include a replacement rack(s) configured to house spare bow and stern modules for modular marine vessels (including single-hull and multi-hull modular marine vessel configurations and of differing lengths). The replacement rack may include features configured to stage replacement modules in a consistent location for external connection to a modular marine vessel payload module and to retract loaded modules to provide room for an additional module within the replacement rack.

Consistent with some embodiments, a replacement rack may include induction coils configured to maintain the charge and operability of stowed modular marine vessel modules.

Consistent with some embodiments, a replacement rack may include external cooling pads and fire-fighting nozzles to control the temperature of stowed modular marine vessel modules (including single-hull and multi-hull modular marine vessel configurations and of differing lengths).

Consistent with some embodiments, an aquatic support vessel may include an in-situ retrieval system(s) that may include a constant lift force mechanism to extend downward over the side of the aquatic support vessel, cross beneath sea level, and provide a platform(s) onto which returning modular marine vessels (including single-hull and multi-hull modular marine vessel configurations and of differing lengths) can navigate for rapid retrieval. In some embodiments, an in-situ retrieval system may include guiding bollards to reduce navigational complexity through contact.

Consistent with some embodiments, an aquatic support vessel may include a retrieval system(s) utilizing a cushioned bollard system placed on the side of the aquatic support vessel to aid in recovery of a deployed modular marine vessels (including single-hull and multi-hull modular marine vessel configurations and of differing lengths) by way of contact with the bow of the modular marine vessel (including single-hull and multi-hull modular marine vessel configurations and of differing lengths). By contacting the cushioned bollard system, the modular marine vessels (including single-hull and multi-hull modular marine vessel configurations and of differing lengths) may locate and orients itself relative to the aquatic support vessel for rapid collection by way of an onboard gantry crane(s).

Consistent with some embodiments, an aquatic support vessel may, either autonomously, remotely, or manually piloted, be equipped with any combination of the systems described herein to provide a unified system to collect, maintain, repair, service, and launch modular marine vessels (including single-hull and multi-hull modular marine vessel configurations and of differing lengths).

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. An aquatic support vessel comprising:
a storage rack configured to stow one or more modular marine vessels;
a gantry crane having a rigid, extendable column configured for lifting one or more of the modular marine vessels one or more of out of the storage rack and placing into the storage rack.

2. The aquatic support vessel according to claim 1, wherein at least a portion of the one or more modular marine vessels include a sea truck comprising:
a bow module;
a payload module comprising one or more of an ISO standard intermodal container and a support frame having ISO standard intermodal container dimensions; and
a propulsion module;
wherein one or more of the bow module, the payload module, and the propulsion module include a plurality of ISO standard intermodal container three-face twistlock connector features for coupling with at least another of the bow module, the payload module, and the propulsion module.

3. The aquatic support vessel according to claim 1, wherein:
the storage rack is configured to stow a plurality of the one or more modular marine vessels in a vertically stacked configuration.

4. The aquatic support vessel according to claim 3, further including a fire control system associated with the storage rack.

5. The aquatic support vessel according to claim 1, further including an inventory control system configured to identify one or more of:
a number of modular marine vessels contained within the storage rack;
a location of one or more modular marine vessels within the storage rack;
a configuration of one or more modular marine vessels within the storage rack; and
a status of one or more modular marine vessels within the storage rack.

6. The aquatic support vessel according to claim 1, further comprising a charging system configured to charge one or more batteries associated with one or more modular marine vessels within the storage rack.

7. The aquatic support vessel according to claim 1, further comprising a communication system configured to communicate with one or more modular marine vessels to one or more of:
identify the one or more modular marine vessels;
determine a configuration of the one or more modular marine vessels;
determine a status of the one or more modular marine vessels; and
provide instructions to the one or more modular marine vessels.

8. The aquatic support vessel according to claim 1, further comprising one or more of:
a replacement rack configured to stow one or more spare module components for the modular marine vessels; and
a removed component rack configured to stow one or more module components removed from the modular marine vessels.

9. The aquatic support vessel according to claim 8, wherein the replacement rack includes an alignment feature for aligning a stowed spare module component with a payload component of one or more of the modular marine vessels for assembling the stowed spare module component with the payload component.

10. The aquatic support vessel according to claim 9, wherein the gantry crane is configured to position a payload module for one or more of the modular marine vessels adjacent the replacement rack for attachment of a spare module component to the payload module.

11. The aquatic support vessel according to claim 8, wherein the gantry crane is configured to position one or more of the modular marine vessels adjacent the removed component rack for removal of a module component from one or more modular marine vessels and stowing of the module component in the removal rack.

12. The aquatic support vessel according to claim 1, wherein the gantry crane includes a trolley having at least a first extendable column and a second extendable column, each configured for lifting a respective one of the one or more of the modular marine vessels one or more of out of the storage rack and placing into the storage rack.

13. The aquatic support vessel according to claim 12, wherein the storage rack includes at least a first storage rack and a second storage rack, and wherein the first extendable column is configured for lifting one of the one or more modular marine vessels from the first storage rack and placing into the first storage rack, and wherein the second extendable column is configured for lifting one of the one or more modular marine vessels from the second storage rack and placing into the second storage rack.

14. The aquatic support vessel according to claim 13, wherein the first and second extendable columns are configured to lift a respective one of the one or more modular marine vessels from the first storage rack and the second storage rack and placing a respective one of the one or more modular marine vessels into the first storage rack and the second storage rack without repositioning the trolly of the gantry crane.

15. The aquatic support vessel according to claim 1, further comprising a retrieval system including a retrieval platform deployable over a side of the aquatic support vessel to a position at least partially below a surrounding water surface to enable one or more of the modular marine vessels to navigate one or more of onto and above the retrieval platform.

16. The aquatic support vessel according to claim 15, wherein the retrieval system includes a constant lift force mechanism for raising the retrieval platform and a modular marine vessel from the surrounding water surface.

17. The aquatic support vessel according to claim 15, wherein the retrieval platform is moveable between a first position oriented generally parallel with a side of the aquatic support vessel, and a second position generally parallel with the surrounding water surface.

18. The aquatic support vessel according to claim 15, wherein the retrieval system includes one or more bollards associated with the retrieval platform to facilitate navigation of the one or more modular marine vessels to navigate to a desired position with respect to the retrieval platform.

19. The aquatic support vessel according to claim 1, further comprising one or more cushioned bollards that are deployable over a side of the aquatic support vessel to a position at or below a surrounding water surface, the one or more cushioned bollards configured to enable a modular maritime vessel to navigate against the one or more cushioned bollards to achieve an orientation generally parallel against the side of the aquatic support vessel.

20. The aquatic support vessel according to claim 19, wherein the gantry crane is configured to retrieve the modular maritime vessel from the generally parallel orientation against the side of the aquatic vessel.
